(19) United States
(12) Patent Application Publication
(10) Pub. No.: US 2008/0080538 A1
(43) Pub. Date: Apr. 3, 2008

(54) Main apparatus of communication system, and registration method for use in the apparatus

(75) Inventor: Fumio Shibasaki, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/898,167

(22) Filed: Sep. 10, 2007

(30) Foreign Application Priority Data
Sep. 28, 2006 (JP) 2006-265979

(51) Int. Cl. H04L 12/66

(52) U.S. Cl. 370/401

(57) ABSTRACT

According to one embodiment, a main apparatus of a communication system includes a communicator which registers a first management table in which terminal IDs specifying the plurality of communication terminals are associated with connection IDs specifying the plurality of interface units to the registration server, to communicate between the communication terminals and the packet communication network through each session of the plurality interface units, and a controller which updates the first management table registered in the registration server to a second management table in which association among the terminal IDs and the connection IDs is changed based on prescribed conditions.

### CROSS-REFERENCE TO RELATED APPLICATIONS

This application is based upon and claims the benefit of priority from Japanese Patent Application No. 2006-265979, filed Sep. 28, 2006, the entire contents of which are incorporated herein by reference.

### BACKGROUND

1. Field

One embodiment of the invention relates to, for example, an Internet protocol (IP) telephone system. More specifically, the present invention relates to a main apparatus of a communication system configured to make voice communications among a plurality of communication terminals and an IP network through interface units, and a registration method for use in the main apparatus.

2. Description of the Related Art

In recent years, a network telephone system (IP telephone system) which interactively transmits and receives an image and a voice as packet data in real time has become widely used. Such an IP telephone system may perform extension communications and outside line outgoing/incoming calls among main apparatus via the IP network as well as perform extension communications and outside line outgoing/incoming calls for each main apparatus connected to the IP network. The IP telephone system has widely used a session initiation protocol (SIP) as its protocol.

This type of system associates URI (terminal ID) of an extension terminal for each main apparatus with identification information (connection ID) of an interface to be used for a connection with the IP network to pre-register it in a server of an enterpriser on the IP network. When makes speeches through the IP network by means of the extension terminals, a server authenticates the extension terminals based on the association between the registered terminal IDs and connection IDs.

The system may register a plurality of interfaces to which the extension terminals are connected in association with priorities in registering the terminal IDs and connection IDs in the server. Therefore, when an interface with the top priority becomes fault, if an incoming call arrives at the extension terminal accommodated in the interface, a first incoming call does not terminate due to the fault of the interface, but the system tray to terminate the first incoming call by shifting to an interface with the next top priority, so that the system becomes able to terminate the incoming call while detouring the fault interface as a result. However, the incoming call is delayed until it is determined that the first incoming call is invalid. Since the system shifts only within a pre-registered range, if all interfaces go wrong, the incoming call may not be terminated.

Conventionally, a concentrator system, which has a plurality of lines to the IP network, reds out a fault state of connection lines, treats the fault connection lines as non-selection objects and connects the terminal to another line if the connection line is in fault, has been proposed (e.g., Jpn. Pat. Appln. KOKAI Publication 2003-111116).

However, when the foregoing concentrator system is applied to an SIP, it becomes necessary to associate between a server of an enterpriser on the IP network and the plurality of lines in advance to register them.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred block diagram illustrating a configuration of an IP network communication system regarding the first embodiment of the invention;

FIG. 2 is a preferred view illustrating a correspondence relation with identification information (connection ID) of local area network (LAN) interfaces which is stored in a database depicted in FIG. 1, and is associated with URIs that are client information to be registered in each enterpriser in accordance with extensions;

FIG. 3 is a preferred view illustrating the number of sessions which is stored in the database depicted in FIG. 1 and is connectable to each enterpriser for each LAN interface unit at the same time;

FIG. 4 is a preferred view illustrating traffic (the averaged number of calls) which is stored in the database depicted in FIG. 1 and is registered for each enterpriser in accordance with extensions;

FIG. 5 is a preferred view illustrating re-distribution registration system to be stored in the database depicted in FIG. 1;

FIG. 6 is a preferred flowchart illustrating a control processing procedure of a registration control unit which re-registers URIs associated with the LAN interface units when an fault occurs at any of the LAN interface units in the first embodiment of the invention; and

FIG. 7 is a preferred view illustrating a management table in which traffic is re-distributed in the first embodiment of the invention.

### DETAILED DESCRIPTION

Various embodiments according to the invention will be described hereinafter with reference to the accompanying drawings. In general, according to one embodiment of the invention, a main apparatus of a communication system which accommodates a plurality of communication terminals and enables being connected with a packet communication network including at least one registration server via a plurality of interface units, comprising: a communicator which registers a first management table in which terminal IDs specifying the plurality of communication terminals are associated with connection IDs specifying the plurality of interface units to the registration server, to communicate between the communication terminals and the packet communication network through each session of the plurality interface units; and a controller which updates the first management table registered in the registration server to a second management table in which association among the terminal IDs and the connection IDs is changed based on prescribed conditions.

### First Embodiment

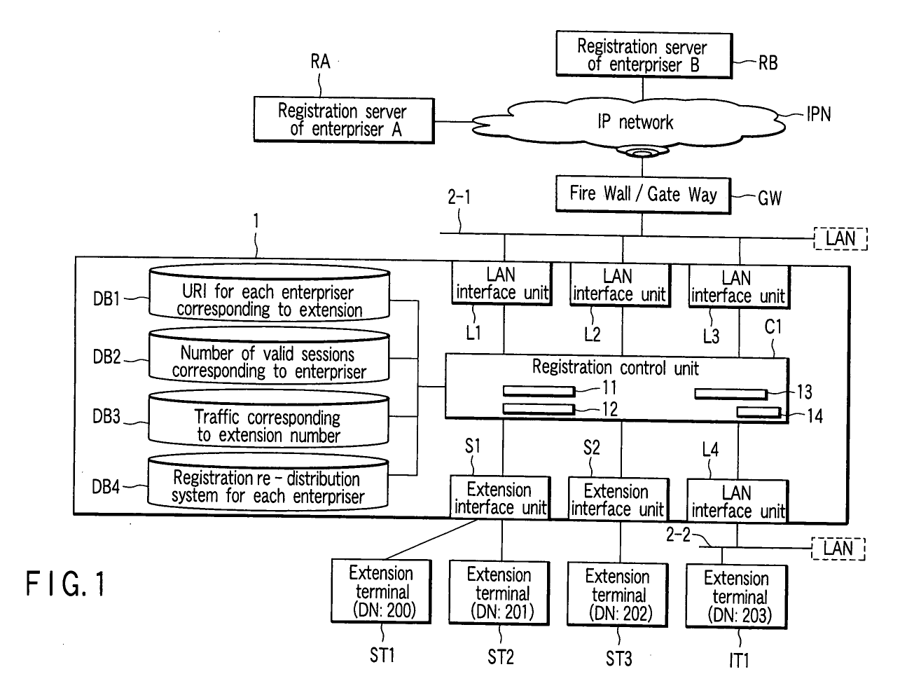

FIG. 1 is a block diagram showing a configuration of an IP network communication system regarding the first embodiment of the invention, and the symbol 1 indicates a main apparatus.

A gateway GW is connected to the main apparatus 1 via a local area network (LAN) 2-1. The gateway GW connects between an IP network IPN and the LAN 2-1, and has a conversion function for a communication protocol and a signal format between the IP network IPN and the LAN 2-1.

Further, registration servers RA and RB of a plurality of enterprisers are connected to the IP network IPN. To make the description short, FIG. 1 shows only two registration servers RA and RB.

The main apparatus 1 has extension interface units S1 and S2, LAN interface units L1-L4, a registration control unit C1, and databases DB1-DB4.

LAN interface units L1-L3 perform interface processing to and from the LAN 2-1.

The LAN interface unit L4 accommodates a LAN 2-2, and an IP extension terminal IT1 is connected to the LAN 2-2. The LAN interface unit L4 conducts an interface operation such as outgoing and incoming call processing to and form the IP extension terminal IT1. The LAN interface unit L4 conducts transmissions and receptions of a variety of items of control information concerning the interface operation for the LAN 2-2 to and from the registration control unit C1. An extension number (DN: 203) is assigned to the IP extension terminal IT1 as a terminal ID.

The extension interface unit S1 accommodates extension terminals ST1 and ST2. The extension interface S1 performs interface operations for the extension terminals ST1 and ST2. The extension interface S1 transmits and receives a variety of kinds of control information regarding the interface operations for the extension terminals ST1 and ST2 to and from the control unit C1. An extension number (DN: 200) is assigned to the extension terminal ST1, and an extension number (DN: 201) is assigned to the extension terminal ST2.

The extension interface unit S2 accommodates an extension terminal ST3. The extension interface unit S2 conducts an interface operation of outgoing and incoming call processing, etc., to the extension terminal ST3. The extension interface unit S2 transmits and receives a variety of kinds of control information concerning interface operations to and from the control unit C1. An extension number (DN: 202) is assigned to the extension terminal ST3.

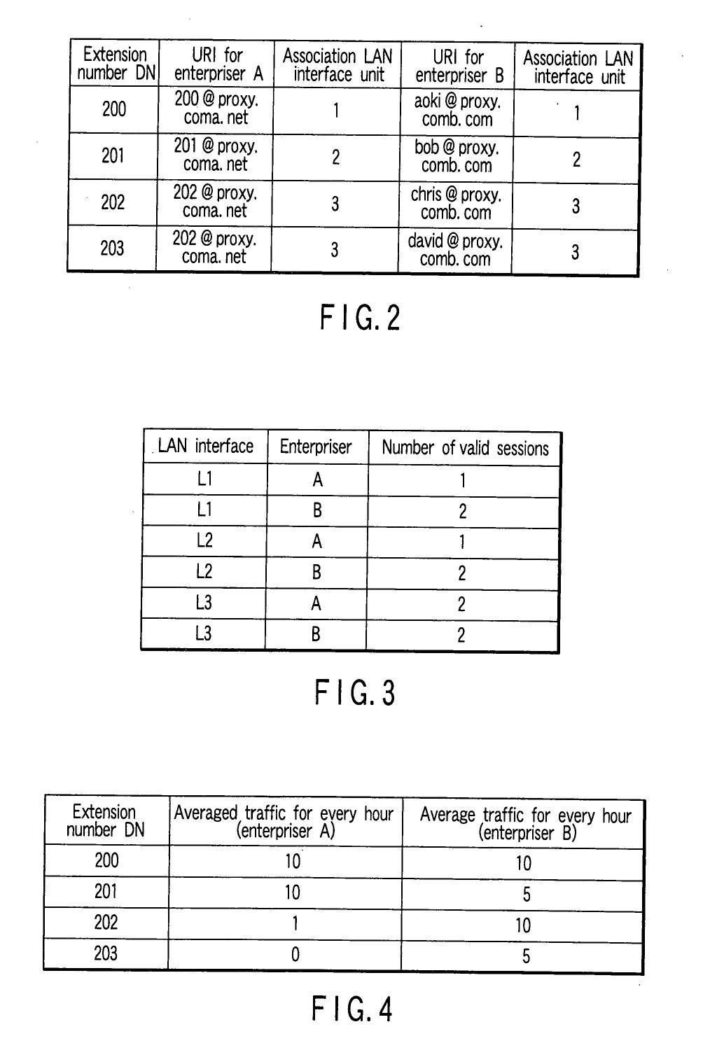

The database DB1 stores, as shown in FIG. 2, identification information (connection ID) of the LAN interface units L1-L3 associated with a URI that is client information to be registered in each enterpriser in accordance with extensions.

The database DB2 stores, as depicted in FIG. 3, how many sessions can be connected at the same time in each enterpriser for each LAN interface unit L1-L3.

The database DB3, as shown in FIG. 4, stores traffic (the number of averaged calls) for each enterpriser in accordance with extensions.

The database DB4 stores, as illustrated in FIG. 5, a system how to re-distribute and register the URI when any fault occurs in the LAN interface units for each enterpriser A and B into the remaining LAN interface unit.

The control unit C1 includes a fault monitoring unit 11, a re-registration control unit 12, a recovery monitoring unit 13 and a traffic storage unit 14 (hereinafter referred to as storage unit 14) in addition to a control function to realize an operation as the main apparatus 1. The fault monitoring unit 11 monitors fault occurrences in the LAN interface units L1-L3.

When a fault is detected by the monitoring unit 11, the control unit 12 refers to the storage contents of the database DB2-DB4, associates the extension terminals ST1-ST3, and IP extension terminal IT1 with normal LAN interface units L1 and L2, updates the storage content of the database DB1, further, and makes communications with the registration servers RA and RB to execute re-registration of the update content of the database DB1 for the registration servers RA and RB.

The recovery monitoring unit 13 monitors a recovery situation of the LAN interface unit L3 in which a fault has occurred.

When the recovery monitoring unit 13 detects the fact of the recovery of the defected LAN interface unit L3, the re-registration control unit 12 returns the storage content of the database DB1 as before, and makes communications with the registration servers RA and RB to return the update content of the database DB1 for the registration servers RA and RB as it was before.

The storage unit 14 measures each pieces of traffic of the extension terminals ST1-ST3, and the IP extension terminal IT1 to store them. The storage unit 14 obtains average of the periodically stored each pieces of traffic of the extension terminals ST1-ST3 and IP extension terminal IT1 to store them in the database DB3.

Next to this, operations of the IP network communication system configured as mentioned above will be described.

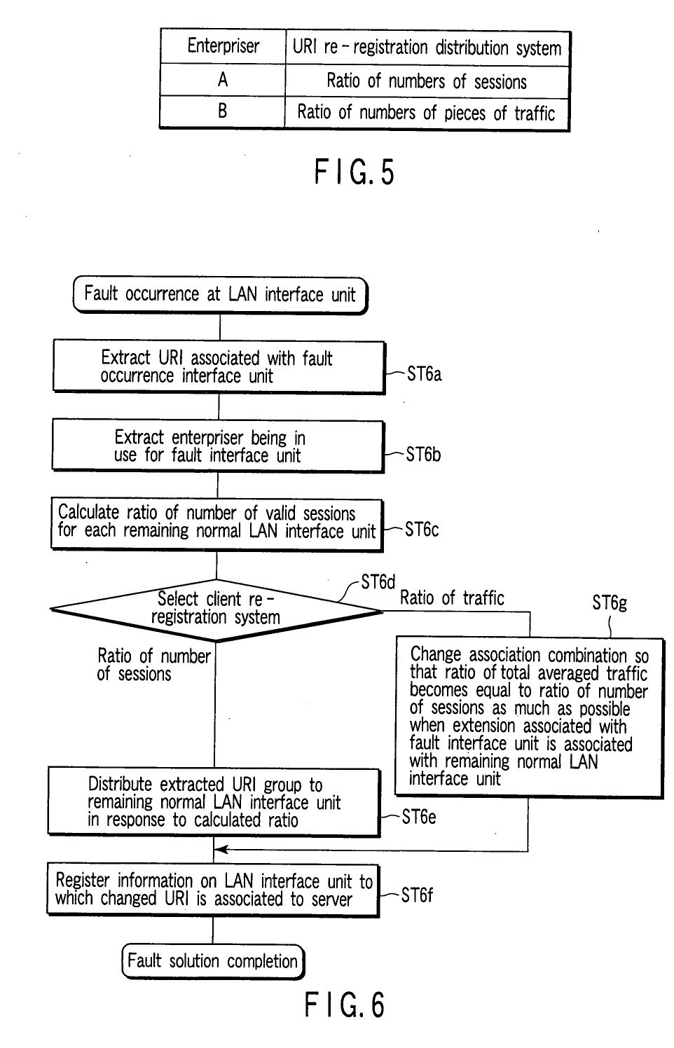

FIG. 6 is a flowchart depicting a control processing procedure of the registration control unit C1 to re-register the URI associated to the LAN interface unit L3 in the case of an occurrence of a fault in the LAN interface unit L3.

The control unit C1 firstly extracts the fact that the extension numbers associated to the LAN interface unit L3 are two of DN: 202, and DN: 203 by referring to the database DB1 (block ST6a).

Next, the control unit C1 extracts the fact that the extension numbers DN 202 and 203 are associated with the enterprisers A and B, respectively, from a reference result to the database DB1 (block ST6b).

The control unit C1 re-registers association information to an enterpriser A in accordance with the following method. Obtaining a ratio of the number of sessions between the remaining normal LAN interface units L1 and L2 by referring to the database DB2 (block ST6c) results in an expression, L1:L2=1:1.

A re-registration distribution system of the enterpriser ‘A’ decides to obtain a ratio of the number of sessions with reference to the database DB4. The control unit C1 then shifts from a block ST6d to a block ST6e, and there, distributes the DN 202 and DN 203 by means of the ratio of the number of sessions of 1:1.

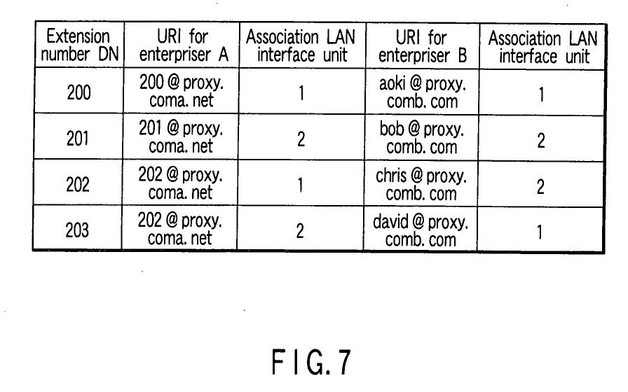

As shown in FIG. 7, the resulting distribution generates a management table in which the DN 202, and DN 203 are re-distributed to the LAN interface units L1 and L2 one by one, respectively, to register this management table in the registration server RA of the enterpriser A (block ST6f). At this moment, the management table is inserted into a REGISTER request defined by the SIP and transmitted to the registration server RA.

As described above, in the first embodiment, for example, in the case of an occurrence of a fault at a LAN interface unit L3, the main apparatus 1 refers to the databases DB2-DB4, associates the terminal ID (DN 202) of the extension terminal ST3 with the connecting ID (1) of the normal LAN interface unit L1 based on the reference result, creates the management table in which the terminal ID (DN 203) of the IP extension terminal IT1 is associated with the connection ID (2) of the normal LAN interface unit L2, and updates the registration content of the registration server RA of the enterpriser A on the IP network IPN to the content of the management table as well as updates the storage content of the database DB1 to the content of the management table.

Accordingly, in the case in which the LAN interface unit L3 is not available due to the occurrence of the fault, the registration control unit C1 can register the re-associated management table in the registration server RA of the enterpriser A, thereby the LAN interface unit L3 to be used in connecting the extension terminal ST3 and the IP extension terminal IT1 to the IP network IPN automatically switches to the normal LAN interface units L1 and L2, and then the control unit C1 may continue the voice communication.

The user of the main apparatus 1 may register association information among the extension terminals ST1-ST3, the IP extension terminal IT1 and the interface units L1-L3 only once in the registration server RA of the enterpriser A, thereby the registration operation may be simplified extremely. Further, as long as the normal LAN interface units L1 and L2 exist, the control unit C1 can execute the re-registration of the management table to the registration server RA repeatedly.

In the first embodiment, when the fault of the LAN interface unit L3 of the main apparatus 1 is recovered, the connection between the IP extension terminal IT1 and the LAN interface unit L3 which have been associated with each other firstly is recovered automatically.

Therefore, for instance, when the fault of the LAN interface unit L3 is returned to normal, the control unit C1 may quickly recover the connection among the firstly associated extension terminal ST3, IP extension terminal IT1 and LAN interface unit L3 without having to wait for a recovery operation by a maintenance person.

Moreover, in the first embodiment, the re-associated management table may be re-registered in the server RA by the use of the existing registration request such as the REGISTER request defined by the SIP.

Accordingly, there is no need to newly set an exclusive signal and re-register the management table to the registration server RA again; and thereby the registration processing may be implemented directly through a further simple processing procedure.

### Second Embodiment

The second embodiment of the invention is related to an example of re-registering association information to the registration server RB of the enterpriser B.

The control unit C1 obtains a ratio between the numbers of sessions of the remaining normal LAN interface units L1 and L2 as, L1:L2=1:1, by referring to the database DB2.

Here, the re-registration distribution system of the enterpriser B decides a distribution ratio as a traffic ratio with reference to the database DB4.

The control unit C1 shifts from the block ST6d to a block ST6g, there distributes the sessions so that the traffic ratio becomes equivalent to ‘1:1’ that is the session ratio as much as possible. That is, since the current traffic ratio of the LAN interface unit L1 to the LAN interface unit L2 is equivalent to the ratio of the extension numbers DN 200 to the DN 201, the resulting ratio becomes, 10:5=2:1. Because the ratio of the numbers of sessions is ‘1:1’, the control unit C1 intends to approach the ratio of traffic in distributing the extension numbers DN 202 and DN 203 becomes close to ‘1:1’ as much as possible.

To make it true of a ratio between traffic of the extension with the extension number DN 200+traffic of a extension re-distributed to the interface unit L1 and traffic of the extension with the extension number DN 201+traffic of the extension re-distributed to the interface unit L2=1:1, if the control unit C1 distributes the extension with DN 203 to the interface unit L1, and the extension with DN 202 to the interface unit L2, it becomes true for the formula, 10+5:5+10=15:15=1:1.

As a result, the control unit C1 re-assigns the extension with DN 202 to the interface unit L2, and the extension with DN 203 to the interface unit L1 one by one to create the management table, then, registers the management table to the registration server RB of the enterpriser B.

The procedure given above completes the re-registration of the URIs to be connected to the enterpriser associated with the defected LAN interface unit L3, then; the control unit C1 terminates the processing. At this moment, the content of the database DB1 has been changed to that of the management table depicted in FIG. 7.

As mentioned above, in the second embodiment, since the control unit C1 executes comparison determination etc. between the ratio of total traffic of the extension terminals ST1, ST2, ST3, and IP extension terminal IT1 and the ratio of the number of available sessions associated to each normal LAN interface unit L1 and L2 by using averaged traffic for each extension terminal ST1, ST2, ST3 and IP extension terminal IT1 stored and managed in and by the database DB3, the control unit C1 may perform association processing of the extension terminals ST1, ST2, ST3 and IP extension terminal IT1 to the normal LAN interface units L1 and L2 with a simple procedure.

### Other Embodiment

The invention is not limited to each embodiment given above. While each embodiment mentioned above has been described about the example to connect the IP network to the main device through the gateway, having the gateway built-in the master device to directly connect the IP network is a possible approach.

Although each embodiment described above has been described about the example to use the REGISTER request of the SIP and reregister the association information to the registration server of the enterpriser on the IP network, it is understood that the re-registration of the association information to the registration server of the enterpriser on the IP network may be carried out by using a protocol other than the SIP.

Other than this, a type and a configuration of a system, a configuration of a master device, a kind of an extension terminal such as a communication terminal, a storage content of each database, a fault detection control procedure and a re-registration control procedure in a LAN interface unit, etc., may be achieved depending on various modifications without departing from the spirit of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A main apparatus of a communication system which accommodates a plurality of communication terminals and enables being connected with a packet communication network including at least one registration server via a plurality of interface units, comprising:
a communicator which registers a first management table in which terminal IDs specifying the plurality of communication terminals are associated with connection IDs specifying the plurality of interface units to the registration server, to communicate between the communication terminals and the packet communication network through each session of the plurality interface units; and
a controller which updates the first management table registered in the registration server to a second management table in which association among the terminal IDs and the connection IDs is changed based on prescribed conditions.

2. The main apparatus according to claim 1, wherein the controller detects faults regarding each communication of the plurality of interface units, and creates the second management table in which association among the terminal IDs and connection IDs of normal interface units is changed based on the detection result.

3. The main apparatus according to claim 2, further comprising:
a monitor which monitors recovery situations of each fault of the plurality of interface units, wherein
the controller returns the second management table registered in the registration server to the first management table, based on the monitoring result by the monitor.

4. The main apparatus according to claim 2, wherein the controller associates the terminal ID with the connection IDs at a ratio of the numbers of usable sessions for each normal interface in creating the second management table.

5. The main apparatus according to claim 2, further comprising:
a memory which stores traffic for each communication terminal, wherein
the controller refers to the traffic for each communication terminal stored in the memory, and associates the plurality of communication terminals with normal interface units that a ratio of a total of the traffic of the communication terminals associated with each normal interface almost coincides with a ratio of the numbers of the usable sessions based on the reference result.

6. The main apparatus according to claim 1, wherein the controller re-associates the terminal IDs with the connection IDs so that the ratio of the total traffic becomes within a reference value to create the second management table, when the total traffic for each interface unit exceeds the reference value as determination of the conditions.

7. The main apparatus according to claim 1, wherein the controller inserts the second management table into a REGISTER request defined by a session initiation protocol and transmits the request to the registration server in updating, to the second management table for the registration server.

8. The main apparatus according to claim 1, further comprising:
a connector to connect with a gateway to be connected with the packet communication network, wherein
the controller makes communications of the first and the second management tables to and from the gateway through the connector.

9. A registration method for use in a main apparatus which accommodates a plurality of communication terminals and enables being connected with a packet communication network including at least one registration server via a plurality of interface units, comprising:
registering a first management table in which terminal IDs specifying the communication terminals are associated with communication IDs specifying the interface units to the registration server in communication among the communication terminals and the packet communication network; and
updating the first management table registered in the registration server to a second management server in which association between the terminal IDs and the connection IDs is changed based on a prescribed conditions.
